(19) United States
(12) Patent Application Publication
(10) Pub. No.: US 2005/0252055 A1
(43) Pub. Date: Nov. 17, 2005

(54) Publicity medium

(76) Inventors: Jean-Luc Pellecuer, Mauguio (FR); Raphael Salles, Grabels (FR)

Correspondence Address: EGBERT LAW OFFICES, 412 MAIN STREET, 7TH FLOOR, HOUSTON, TX, 77002, US

(21) Appl. No.: 10/513,635

(22) PCT Filed: May 6, 2003
(86) PCT No.: PCT/FR03/01396

§ 371 Date: May 13, 2005

(30) Foreign Application Priority Data
May 10, 2002 (FR) 02/05788

(51) Int. Cl. G09F 15/00

(52) U.S. Cl. 40/610

(57) ABSTRACT

The invention relates to a publicity medium which is intended to be used during outdoor or indoor commercial, sporting or other types of events. The device includes flexible panels, the panels being stretched over and/or fixed to a support structure. The support structure has an assembly of tubes which are inflated at a relative pressure of between 0.15 and 0.8 bars.

### RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention refers to a communication carrying device, in particular for use during commercial, sports or other indoor or outdoor events.

Such a communication carrying device is in particular aimed at being a meeting place, visible from a considerable distance because of its original esthetics and its particular dimensions.

### BACKGROUND OF THE INVENTION

Currently known communication carrying devices consist of rigid panels, or of flexible panels stretched and/or fixed on a rigid structure such as a metal frame, said panels carrying the information to be spread.

Such devices have disadvantages, in particular regarding their transport and sometimes their implementation.

### BRIEF SUMMARY OF THE INVENTION

This invention is aimed at providing a communication carrying device permitting to cope with these various disadvantages.

The communication carrying device, in particular for use during commercial, sports or other indoor or outdoor events according to the invention, is of the type comprising flexible panels containing the information to be spread, said panels being stretched and/or fixed on a bearing structure, and it is essentially characterized in that said bearing structure consists, of an association of tubes inflated at a relative pressure between 0.15 and 0.8 bars.

According to an additional feature of the device according to the invention, the structure includes at least three inflatable tubes of a slightly truncated conical shape, at the end with the largest cross-section of which is made integral a base, bases being laid on the ground and spaced from each other by a certain distance, whereas the other ends, of a narrower cross-section, are put together to form the top of the structure.

According to another additional feature of the device according to the invention, the bases consist of plates.

According to another additional feature of the device according to the invention, the bearing structure includes, near its top, tubes arranged transversally between two adjacent tubes.

According to another additional feature of the device according to the invention, the bearing structure includes transversal tubes extending between two non adjacent tubes.

According to another additional feature of the device according to the invention, the flexible panels on which appear the information to be spread are in the form of canvases extending between some of the tubes of the structure.

According to another additional feature of the device according to the invention, each tube includes an elastic impermeable internal envelope, and an external envelope made of an inelastic resistant tissue.

Preferably, the external envelope is made of Mylar®, Dacron® or the like.

According to another additional feature of the device according to the invention, the integral connection of the tubes to each other and of the panels to the tubes is made by means of sewing operations.

Sewing has the advantage of improving the stability of the structure by making integral the tubes at a point.

It should be noted that advantageously the panels, or just some of them, can be made integral with the tubes by means for reversible fastening.

Also, it should be noted that it is absolutely possible to use the surface of the tubes for spreading information.

A device according to the invention made in this way has an exceptional weight/rigidity ratio, which permits to solve problems experiences with the current devices, viz. problems of weight, space, transport, installation, safety . . .

Furthermore, the device according to the invention has advantageously an interesting esthetic.

The advantages and the features of the device according to the invention will become clear from the following description, when referring to the attached drawing, which represents a non-restrictive embodiment thereof.

### BRIEF DESCRIPTION OF THE SEVERAL VIEWS OF THE DRAWINGS

In the attached drawing:

FIG. 1 represents a schematic perspective view of a communication carrying device according to the invention.

FIG. 2 represents a schematic perspective view of a variant of the same device.

### DETAILED DESCRIPTION OF THE INVENTION

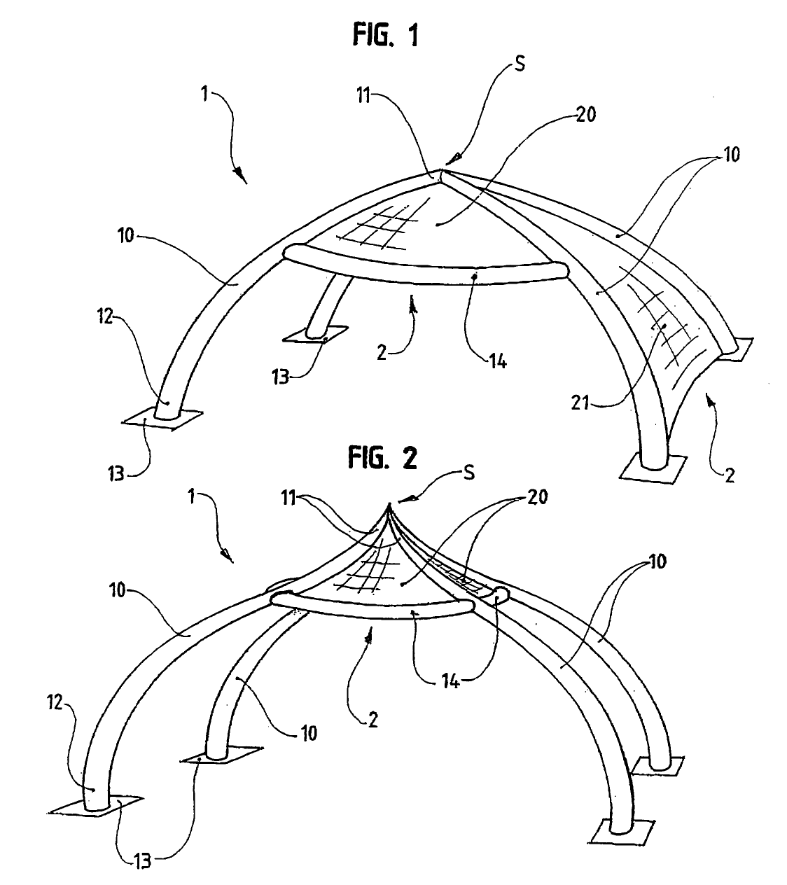

Referring to FIG. 1, it can be seen that a communication carrying device, in particular for use during commercial, sports, and other indoor or outdoor events, according to the invention includes a bearing structure 1 comprising four tubes 10 inflatable at high pressure, made integral with each other by an end 11 in order to form the top S of the device, whereas their other end 12 includes abase 13.

The bases 13 consist of plates made integral with the ends 12 of the tubes, which are spaced from each other at a certain distance and are likely to be covered with heavy elements, snow, sand, etc. . . . , in order to ensure the anchoring of the structure 1 to the ground.

It should be noted that the tubes 10 have preferably a truncated conical shape, i.e. the ends 12 have a cross-section larger than that of the ends 11. This feature enhances the stability of the bearing structure 1.

The bearing structure 1 also includes a transversal tube 14, extending between two adjacent tubes 10 near the top S.

It should be noted that such a tube 14 can extend between each pair of adjacent tubes 10.

It should also be noted, in a variant that is not shown, that the bearing structure 1 can include transversal tubes extending between two non adjacent tubes 10, in this case between two tubes 10 opposite each other, since the bearing structure 1 shown includes four tubes 10. This disposition also aims to enhance the stability of the whole.

The device according to the invention also includes panels 2 bearing information aimed at being spread, which consist of pieces of canvas, and which, in the embodiment shown, adopt two different forms, viz. a canvas 20 extending between the top S, a tube 14 and two adjacent tubes 10, and a canvas 21 extending between two adjacent tubes 10, from the top S to the ends 12.

When referring now to FIG. 2, a variant of the communication carrying device according to the invention can be seen.

It also includes a structure 1 formed by assembling tubes 10 and transversal tubes, associated with panels 2 consisting of canvases 20 extending between the top S, a tube 14 and two adjacent tubes 10.

This device according to the invention differs from the preceding ones essentially in that the ends 11 of the tubes 10 are put together side-by-side, and not end-to-end, in order to provide the structure with a pointed and non ogival shape.

In both embodiments, the integral connection of the panels 2 to the bearing structure 10 is made by sewing and/or through means permitting a reversible fastening.

It is obvious that this invention cannot be limited to the preceding description of several of its embodiments, and that it can undergo some changes without departing from the scope of the invention.

1. Communication carrying device, for use during commercial, sports, and other indoor or outdoor events, the device comprising:
flexible panels having information spread thereon; and
a bearing structure attachable to said flexible panels by being stretched and/or fixed thereto, said bearing structure being comprised of at least three tubes of slightly truncated conical shape, inflated at a relative pressure between 0.15 and 0.8 bars, and a base made integral with an end of a largest cross-section of each one of the tubes, each of the bases being positionable on a ground area and spaced from each other by a certain distance, wherein other ends of a narrower cross-section, are form a top of the bearing structure, and wherein said bearing structure further comprises transversal tubes near said top of said bearing structure, said transversal tubes being arranged transversally between the tubes, whether adjacent or not.

2. Device according to claim 1, wherein said bases are comprised of plates.

3. Device according to claim 2, wherein said flexible panels are comprised of canvases extending between the tubes of the bearing structure.

4. Device according to claim 1, wherein each tube comprises an internal elastic impermeable envelope, and an external envelope comprised of an inelastic resistant tissue.

5. Device according to claim 4, wherein the internal envelope is comprised of latex or similar; and wherein said external envelope is comprised of Mylar®, Dacron® or similar.

6. Device according to claim 1, wherein an integral connection of tubes to each other and of panels to tubes is formed by sewing operations.

7. Device according to claim 1, wherein said flexible panels being stretched and/or fixed on an element of the structure are attachable to flexible panels of a separate communication carrying device.

8. Device according to claim 1, wherein the tubes of the bearing structure have an arched shape determining tension of the flexible panels.
